(19) United States
(12) Patent Application Publication
(10) Pub. No.: US 2009/0285571 A1
(43) Pub. Date: Nov. 19, 2009

(54) IMAGE DETECTING MODULE AND POSITIONING MECHANISM THEREOF

(75) Inventor: Yaw-Ching Huang, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/178,670

(22) Filed: Jul. 24, 2008

(30) Foreign Application Priority Data
May 13, 2008 (CN) 97117541

(51) Int. Cl. G03B 17/00

(52) U.S. Cl. 396/55

(57) ABSTRACT

An image detecting module is disclosed, including a base, a first magnetic element fixed to the base, a slider movably connected to the base, a second magnetic element disposed on the slider, an image detecting unit disposed on the slider, and a coil disposed on the slider or the base. The slider is held in a predetermined position by magnetic attraction between the first and second magnetic elements when no electric current is driven through the coil. When an electric current is driven through the coil, an electromagnetic field is induced by the electric current to eliminate magnetic attraction between the first and second magnetic elements, such that the image detecting unit and the slider are released from the predetermined position and movable with respect to the base.

### BACKGROUND OF THE INVENTION

1. Field of the Invention

The invention relates in general to a positioning mechanism and in particular to a positioning mechanism disposed in an image detecting module of a camera.

2. Description of the Related Art

Referring to FIG. 1, U.S. Pat. No. 5,266,988 discloses an image shake suppressing device for a camera. The image shake suppressing device is mounted in a lens 32. When using the camera, the angular velocity meters 33p and 33y measure the angular velocity of the moving camera and provide the measured data to a circuit. The driving parts 37p and 37y impel the lens 32 along a vertical optical axis, thereby compensating or suppressing blur due to vibration of the camera. When the image shake suppressing device is not in use, power is still supplied to the driving parts 37p and 37y, and this may result in considerable power consumption.

### BRIEF SUMMARY OF INVENTION

The invention provides an image detecting module comprising a base, a first magnetic element fixed to the base, a slider movably connected to the base, a second magnetic element disposed on the slider, an image detecting unit disposed on the slider, and a coil disposed on the slider or the base. The slider is held in a predetermined position by magnetic attraction between the first and second magnetic elements when no electric current is driven through the coil. When an electric current is driven through the coil, an electromagnetic field is induced by the electric current to eliminate magnetic attraction between the first and second magnetic elements, such that the image detecting unit and the slider are released from the predetermined position and movable with respect to the base.

### BRIEF DESCRIPTION OF DRAWINGS

The invention can be more fully understood by reading the subsequent detailed description and examples with references made to the accompanying drawings, wherein:

FIG. 1 is a perspective diagram of a conventional image shake suppressing device for a camera;

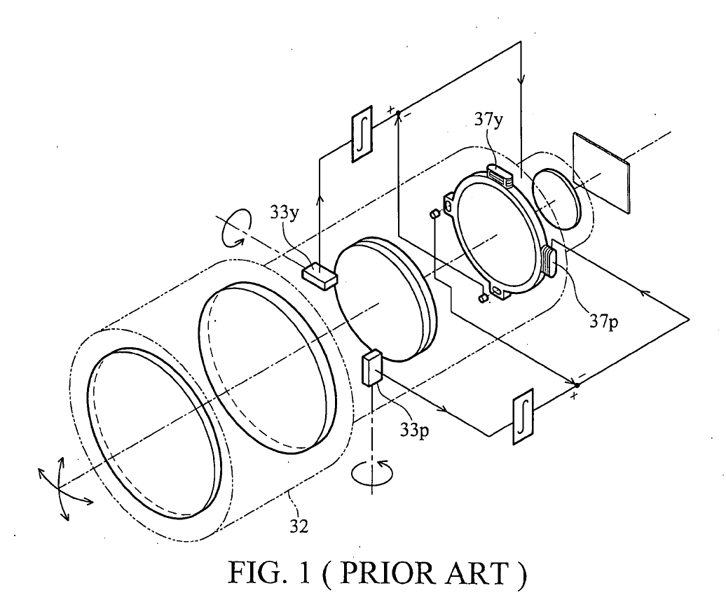

FIG. 2 is a perspective diagram of a positioning mechanism according to an embodiment of the invention;

FIG. 3 is a top view of the positioning mechanism in FIG. 2;

FIG. 4A is a sectional view along A1-A2 in FIG. 3;

FIG. 4B is a perspective diagram of an electromagnetic field induced by a coil; and

FIGS. 5 and 6 are perspective diagrams of a slider moving with respect to a base.

### DETAILED DESCRIPTION OF INVENTION

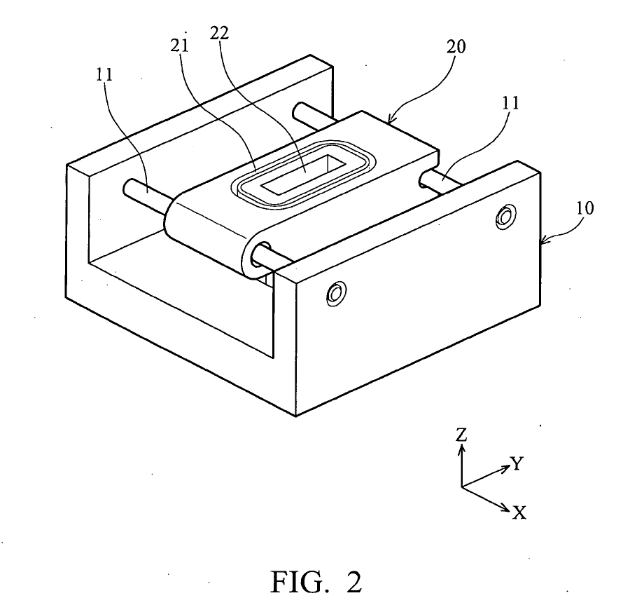

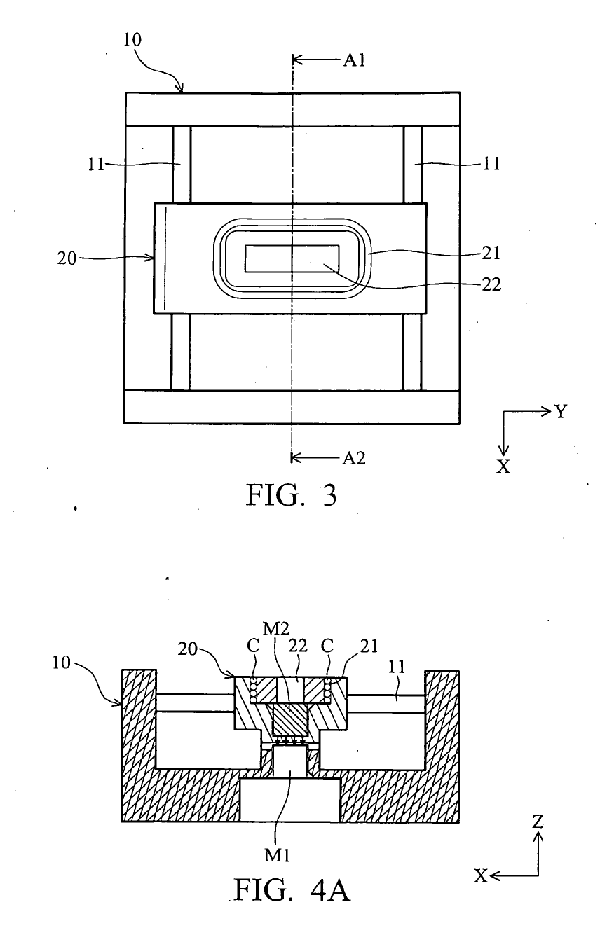

Referring to FIGS. 2 and 3, an embodiment of a positioning mechanism is disposed in an image detecting module of a camera, to compensate for image blur caused by hand shake or movement of the photographer. The positioning mechanism primarily comprises a base 10 and a slider 20, wherein the base 10 is fixed to a lens (not shown) of the camera, and an image detecting unit (not shown) is mounted on the slider 20 for image detection.

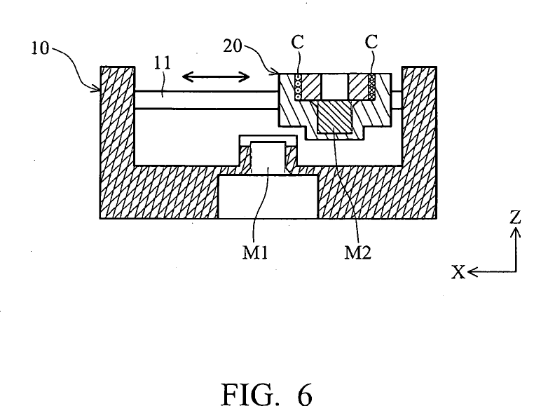

As shown in FIGS. 2 and 3, when the shutter of the camera is closed, the image detecting unit and the slider 20 is held in a predetermined position above the base 10 by magnetic attraction. Alternatively, when the photographer opens the shutter and switches the image detecting module to a focusing or photography mode, the slider 20 is released from the predetermined position and movable along the rails 11, parallel to X axis, as shown in FIGS. 5 and 6.

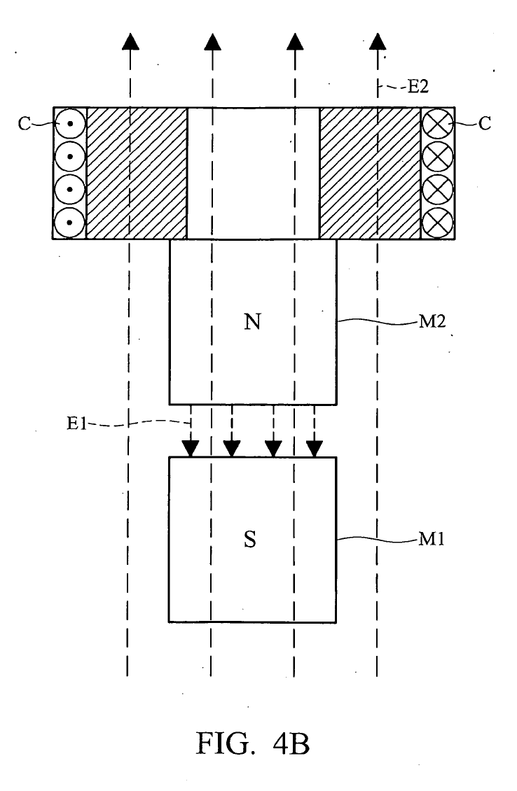

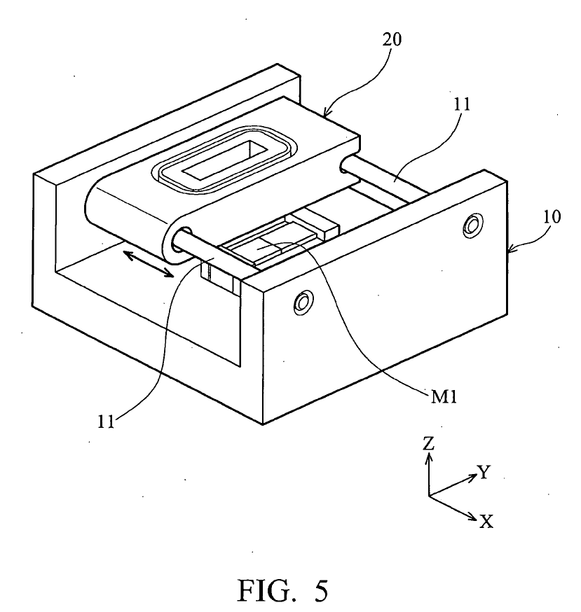

FIG. 4A is a sectional view along A1-A2 in FIG. 3, wherein a first magnetic element M1 is disposed on the base 10, and a second magnetic element M2 is disposed in the slider 20, opposite to the first magnetic element M1. In this embodiment, the first and second magnetic elements M1 and M2 are permanent magnets attracting each other, so as to hold the slider 20 in a predetermined position above the base 10.

As shown in FIGS. 3 and 4A, the slider 20 has an opening 22 and an annular recess 21 around the opening 22 for receiving a coil C (the coil C is omitted in FIGS. 2 and 3). When the shutter is closed, no electric current is driven through the coil C, and the slider 20 is held in the predetermined position by magnetic attraction between the first and second magnetic elements M1 and M2. When the photographer opens the shutter and switches the image detecting module to a focusing or photography mode, an electric current is driven from a power supply to the coil C and induces an electromagnetic field E2, as shown in FIG. 4B. Intensity of the electromagnetic field E2 depends on the current flow through the coil C, and direction of the electromagnetic field E2 is determined by applying Ampere's right-hand rule.

In FIG. 4B, the first and second magnetic elements M1 and M2 produce a magnetic field E1 downwardly (from N to S), and the electric current through coil C induces an electromagnetic field E2 upwardly, opposite to the magnetic field E1, to eliminate magnetic attraction between the first and second magnetic elements M1 and M2. Hence, the slider 20 and the image detecting unit are released from the predetermined position and horizontally movable with respect to the base 10, as shown in FIGS. 5 and 6, to compensate for image blur caused by hand shake or movement of the photographer.

In some embodiments, the coil C can also be disposed on the base 10 to induce an electromagnetic field and eliminate magnetic attraction between the first and second magnetic elements M1 and M2, whereby that the slider 20 is released and movable with respect to the base 10 when the photographer opens the shutter. Specifically, when the camera is not in use, no electric current is supplied to the coil C, and the slider 20 is held in a predetermined position above the base 10 by magnetic attraction between the first and second magnetic elements M1 and M2 without power consumption.

The invention provides an image detecting module of a camera which has a positioning mechanism. The positioning mechanism includes two magnetic elements attracting each other without power consumption, saving more power than conventional image shake suppressing devices. When the photographer opens the shutter for focusing or photography, an electric current is driven through a coil to induce an electromagnetic field and eliminate magnetic attraction between the magnetic elements, thus releasing the image detecting unit and compensating for image blur caused by hand shake or movement of the photographer.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An image detecting module, comprising:
a base;
a first magnetic element fixed to the base;
a slider movably connected to the base;
a second magnetic element disposed on the slider;
an image detecting unit disposed on the slider; and
a coil disposed on the slider or the base, wherein when no electric current is driven through the coil, the slider is held in a predetermined position by magnetic attraction between the first and second magnetic elements, and when an electric current is driven through the coil, an electromagnetic field is induced by the electric current to eliminate magnetic attraction between the first and second magnetic elements, such that the image detecting unit and the slider are released from the predetermined position and movable with respect to the base.

2. The image detecting module as claimed in claim 1, wherein the base comprises a rail with the slider sliding thereon.

3. The image detecting module as claimed in claim 1, wherein the slider comprises an annular recess with the coil received therein.

4. The image detecting module as claimed in claim 1, wherein the first magnetic element is a permanent magnet.

5. The image detecting module as claimed in claim 1, wherein the second magnetic element is a permanent magnet.

6. The image detecting module as claimed in claim 1, wherein when the image detecting module is in a focusing mode, the electric current is driven from a power supply to the coil, such that the image detecting unit and the slider are released from the predetermined position and movable with respect to the base.

7. The image detecting module as claimed in claim 1, wherein when the image detecting module is in a photography mode, the electric current is driven from a power supply to the coil, such that the image detecting unit and the slider are released from the predetermined position and movable with respect to the base.

8. A positioning mechanism, comprising:
a base;
a first magnetic element fixed to the base;
a slider movably connected to the base;
a second magnetic element disposed on the slider; and
a coil disposed on the slider or the base, wherein when no electric current is driven through the coil, the slider is held in a predetermined position by magnetic attraction between the first and second magnetic elements, and when an electric current is driven through the coil, an electromagnetic field is induced by the electric current to eliminate magnetic attraction between the first and second magnetic elements, such that the slider is released from the predetermined position and movable with respect to the base.

9. The positioning mechanism as claimed in claim 8, wherein the base comprises a rail with the slider sliding thereon.

10. The positioning mechanism as claimed in claim 8, wherein the slider comprises an annular recess with the coil received therein.

11. The positioning mechanism as claimed in claim 8, wherein the first magnetic element is a permanent magnet.

12. The positioning mechanism as claimed in claim 8, wherein the second magnetic element is a permanent magnet.
